(19) United States
(12) Patent Application Publication
(10) Pub. No.: US 2019/0236914 A1
(43) Pub. Date: Aug. 1, 2019

(54) POSITION-BASED COMMUNICATION SYSTEM

(71) Applicant: Dirk Dean Duncan, Star, ID (US)

(72) Inventor: Dirk Dean Duncan, Star, ID (US)

(21) Appl. No.: 16/259,545

(22) Filed: Jan. 28, 2019

Related U.S. Application Data
(60) Provisional application No. 62/622,597, filed on Jan. 26, 2018.

(51) Int. Cl. G08B 3/10; H04W 4/021; H04W 4/08

(52) U.S. Cl. CPC G08B 3/1091; G08B 3/1083; H04W 4/08; H04W 4/021; G08B 3/1025

(57) ABSTRACT

A method for providing position-based communication is provided. The position-based communication system determines a list of registered users; associating an ear bud for each listed registered user, wherein each ear bud is coupled to a speaker. The position-based communication system receives, via one or more beacons, one or more configurable security parameters defining a geofence environment, or alternatively a configurable geolocation distance from a software application. Each computing device when within the geofence environment or configurable geolocation distance is adapted to activate an operatively associated microphone; identify one or more registered users within the geofence environment or the configurable geolocation distance; and transmit signals received by the microphone to the speaker of each ear bud.

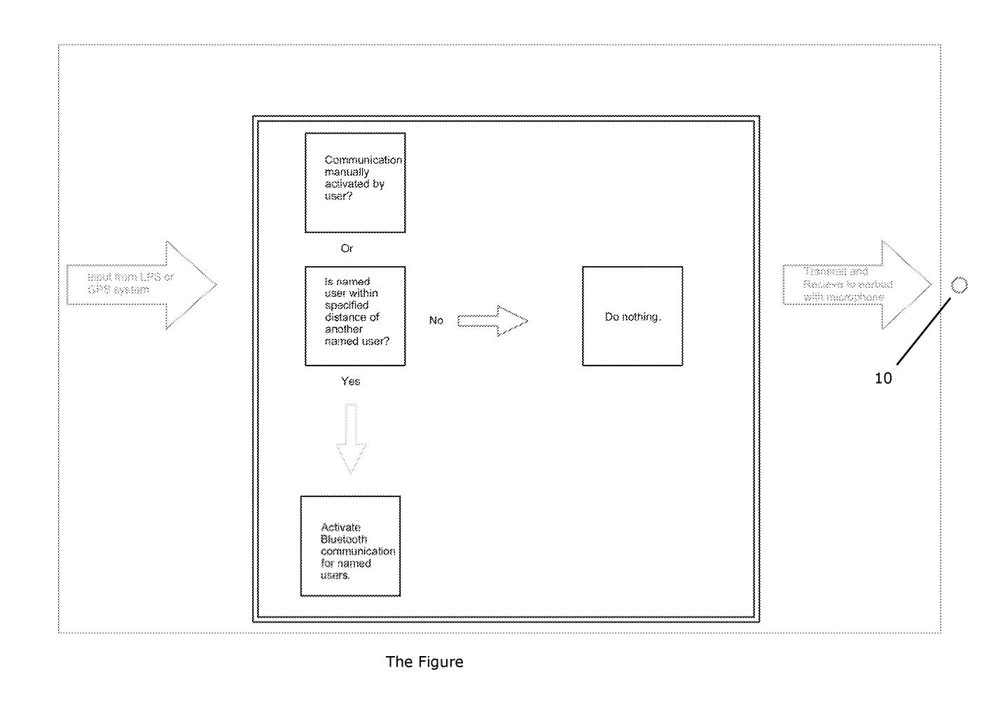

### CROSS-REFERENCE TO RELATED APPLICATION

This application claims the benefit of priority of U.S. provisional application No. 62/622,597, filed 26 Jan. 2018, the contents of which are herein incorporated by reference.

### BACKGROUND OF THE INVENTION

The present invention relates to communication systems and, more particularly, to a position-based communication system.

In a noisy production environment, such as a construction site, a factory floor, or the like, wireless communication can be a challenge and be dangerous. For example, in an attempt to overcome this challenge, individuals risk damaging their hearing as the seek to hear what is being communicated to them. Current solutions, provide devices that are push-to-talk so that a user has to handle the radio or phone, which require users to remove any hearing protection and of course prevents them from using that hand for other purposes. Furthermore, communication via conventional cell phones typically encounter the additional problem of unreliable signals.

As can be seen, there is a need for a position-based communication system enabling hands-free communication with hearing protection. The position-based communication system embodied by the present invention also provides the ability to locate employees within a defined area of communication—a geofence environment. In short, the present invention provides a software-driven, hands-free solution so that user's never have to handle the phone, the signal is always good, and users never have to remove the hearing protection to hear. The software application is adapted turn registered user's smart phone into an open microphone based on blue tooth beacons to define the geofence environment. The present invention also embodies ear buds, providing hearing protection, and coupled to a speaker.

### SUMMARY OF THE INVENTION

In one aspect of the present invention, a method for providing position-based communication among a plurality of registered users, each registered user associated with a computing device having a microphone and a transmitter for exporting signals received by the microphone, includes the following: determining a list of registered users; associating an ear bud for each listed registered user, wherein each ear bud is coupled to a speaker; receiving, via one or more beacons, one or more configurable security parameters defining a geofence environment, wherein each computing device when within the geofence environment is adapted to: activate an operatively associated microphone; identify one or more registered users within the geofence environment through determining if the associated computing devices is within the geofence environment; and transmit signals received by the microphone via the transmitter to the speaker of each ear bud associated with the one or more registered users within the geofence environment.

In another aspect of the present invention, a method for providing position-based communication among a plurality of registered users, each registered user associated with a computing device having a microphone and a transmitter for exporting signals received by the microphone, includes the following: determining a list of registered users, each having an associated computing device, wherein each device is transmitting a real-time geolocation information; associating an ear bud for each listed registered user, wherein each ear bud is coupled to a speaker; receiving, via a software application a configurable geolocation distance, wherein each computing device is configured to determine at least in part on the respective real-time geolocation information of each computing device whether each computing devices is within the configurable geolocation distance, wherein each computing device within the configurable geolocation distance of one or more computing devices, is adapted to: activate an operatively associated microphone; and transmit signals received by the microphone via the transmitter to the speaker of each ear bud associated with the one or more registered users within the configurable geolocation distance.

These and other features, aspects and advantages of the present invention will become better understood with reference to the following drawings, description and claims.

### BRIEF DESCRIPTION OF THE DRAWINGS

The sole FIGURE is a schematic flowchart view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a

Referring to the sole FIGURE, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention includes noise-cancelling ear bud 10 coupled to a speaker. The software application is adapted to identify who is currently “signed in” or registered and provides a list of those “registered users”, each associated with a computing device and an ear bud 10. Utilization of the list of registered users gives a user the ability to speak to one or several registered users within a defined geofence environment or within a configurable geolocation distance. By pressing a talk button, a line of communication is opened which allows those selected to communicate hands-free (without removing hearing protection) and talking without the need to raise your voice.

A plurality of blue tooth or other wireless beacons may be spaced apart to define the geofence environment. Global positioning systems (GPS) or LPS may be used to generate geolocation information to determine if two registered users/computing devices are within the configurable geolocation distance. Through the software application loaded onto a computer such as an android or apple mobile phone or device, a user will be identified and have the ability to communicate hands free directly with another or several users within the designated geofence/geolocation distance. By following the above-mentioned steps, the present invention allows a user to communicate hands-free with another registered within a defined area geofence environment or within a configurable geolocation distance without removing the hearing protection afforded to them by their ear buds 10. Which would be a boon in the medical field, construction, restaurants, hotels, general business, sporting events, security, and the like.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for providing position-based communication among a plurality of registered users, each registered user associated with a computing device having a microphone and a transmitter for exporting signals received by the microphone, comprising:
determining a list of registered users;
associating an ear bud for each listed registered user, wherein each ear bud is coupled to a speaker;
receiving, via one or more beacons, one or more configurable security parameters defining a geofence environment,
wherein each computing device when within the geofence environment is configured to:
activate an operatively associated microphone;
identify one or more registered users within the geofence environment through determining if the associated computing devices is within the geofence environment; and
transmit signals received by the microphone via the transmitter to the speaker of each ear bud associated with the one or more registered users within the geofence environment.

2. The method of claim 1, wherein each ear bud is noise cancelling.

3. The method of claim 1, wherein each computing device provides a global positioning system to facilitate the identification of registered users within the geofence environment.

4. A method for providing position-based communication among a plurality of registered users, each registered user associated with a computing device having a microphone and a transmitter for exporting signals received by the microphone, comprising:
determining a list of registered users, each having an associated computing device, wherein each device is transmitting a real-time geolocation information;
associating an ear bud for each listed registered user, wherein each ear bud is coupled to a speaker;
receiving, via a software application a configurable geolocation distance,
wherein each computing device is configured to determine at least in part on the respective real-time geolocation information of each computing device whether each computing devices is within the configurable geolocation distance,
wherein each computing device within the configurable geolocation distance of one or more computing devices, is configured to:
activate an operatively associated microphone; and
transmit signals received by the microphone via the transmitter to the speaker of each ear bud associated with the one or more registered users within the configurable geolocation distance.

5. The method of claim 4, wherein each ear bud is noise cancelling.

6. The method of claim 4, wherein each computing device provides a global positioning system to generate geolocation information.
